(19) United States
(12) Patent Application Publication
(10) Pub. No.: US 2010/0066043 A1
(43) Pub. Date: Mar. 18, 2010

(54) SHOPPING CART WITH DISPLACEABLE FRONT WALL

(76) Inventor: BRUCE M. TYRRELL, Fort Lauderdale, FL (US)

Correspondence Address: GRAY ROBINSON, P.A., P.O. Box 2328, FT. LAUDERDALE, FL, 33303-9998, US

(21) Appl. No.: 12/496,433

(22) Filed: Jul. 1, 2009

Related U.S. Application Data
(63) Continuation-in-part of application No. 12/231,837, filed on Sep. 5, 2008.

(51) Int. Cl. B62D 39/00

(52) U.S. Cl. 280/33.992

(57) ABSTRACT

A shopping cart having a displaceable front wall, with or without a load carrying apparatus associated with the front wall to provide a horizontal support for safely carrying loads that are longer than the length of the cart and must sit on top of the cart basket to be transported. The front wall and support (if employed) may be used with any conventional shopping cart having nestable or non-nestable baskets. The front wall is hingedly attached to a lower structural member of the cart basket. The front wall is movable from a first retracted position in which it lays substantially in registry with the bottom wall of the cart basket, allowing the basket to be nested into an adjacent cart, to an in-use position in which it forms a shopping cart front wall, to a second retracted position in which it is resting underneath and substantially in registry with the bottom wall of the basket, also allowing the basket to be nested into an adjacent cart.

### REFERENCE TO RELATED APPLICATION

This application is continuation in part of U.S. patent application Ser. No. 12/231,837, filed Sep. 5, 2008, and applicant claims priority thereto under 35 USC 119.

### BACKGROUND OF THE INVENTION

### Field of the Invention

The present invention relates generally to shopping carts, and more particularly relates to shopping carts having a displaceable front wall.

### BACKGROUND OF THE INVENTION

Most shopping carts are constructed of a basket, normally formed of strands of wire, known as “stringers”, welded together to form a basket having an open top, fixed front, rear and side walls, and a substantially horizontal floor, all sitting atop a lower chassis having wheels. A push handle is affixed to the rear of the cart.

Shopping carts need to he stored when not in use and can be nested to conserve space. This is done by the rear wall of the basket of the cart, underneath the push handle of the cart, being hinged nearest the handle arid swinging forward and upward so that a front end of another cart may be pushed therein in a nesting fashion to conserve storage space. To permit this nesting operation the basket of the carts must be tapered, with the projected area of the front of the cart basket being smaller than the projected area of the rear of the cart basket nearest the handle. Due to the tapered shape of the cart basket, a plane passing through both the handle and the top horizontal wire or edge of the front wall of the basket is not horizontal (i.e., is not parallel to the ground),

In many hardware and building goods stores, such nesting carts are utilized. In addition, larger flat bed and other carts designed to carry loads that are larger than the nestable carts normally carry are provided to carry lumber, plywood, pipe and other items that cannot fit into the conventional nestable carts. A problem exists in that, too often, the larger carts are all in use, so shoppers try to make do with the conventional nestable carts when they are purchasing one or a few pieces of larger items such as lumber and pipe that are long and do not lit well inside the cart. The shoppers position such longer items on top of the cart, supported by the handle of the cart and the top horizontal edge of the front wall of the basket. However, since the handle and the top edge of the front wall do not lie in a horizontal plane, the longer items sitting on top of the cart have a tendency to fall off or almost fall off and continuously need repositioning. Needless to say, this is a dangerous condition, and people get hurt when long loads positioned on top of the cart basket shift and fall due to their weight, or when they are inadvertently bumped and fall off the top of the cart basket. This also happens with non-nestable carts, the tops of which are level.

Another problem arises due to the fact that the front a side walls of the baskets are fixed, as is the handle. Because of this, a user who wants to place a heavy item in the basket while shopping, such as a gallon of paint, has to raise the item high enough to clear the top wire and/or handle of the cart. For many users, this is either very difficult or even impossible, which may even lead to the user foregoing the purchase of certain products. The number of such products in the typical home improvement store is substantial, leading to an unknown number of lost sales.

In the past, efforts have been devoted to attempt to remedy the aforementioned shortcomings in the shopping cart field. For example, U.S. Patent Application Publication No. US 2005/0212234 to McFarland discloses an attachment adapted to be connected to the upper end of the front wall of a shopping cart basket. The attachment includes a horizontal bar that is adapted to support a long load in a horizontal orientation on the cart. The attachment is hingedly connected to the front wall of the basket near an upper edge of the front will so that the attachment can rotate between an upright position in which it can support a load to be carried by the cart and a stored position in which the attachment lies flat, in a vertical orientation, against the inside of the front wall of the basket. The attachment is not supported against the substantial horizontal loading imposed upon it by the loads which it is adapted to support. Consequently, the attachment is subject to easy failure.

U.S. Pat. No. 7,13,898 similarly discloses a support which is attached to the top edge of the front of a shopping cart basket, and includes a horizontal bar which is located in a horizontal plane coincident with the shopping cart handle when the support is attached to the cart in its in use position. Like the support in the McFarland application, the support is attached at the top of the front wall of the basket. Consequently, forces exerted on the load being supported by the support and the handle which are imposed toward the rear of the cart will have a tendency to cause the support to rotate to its retracted position, which in turn would cause the load to fall.

U.S. Pat. No, 6,641,147 to Werner discloses, at FIG. 7, a support bracket having a pair of downwardly depending legs which fit within corresponding sockets in a plate attached to the front wall of the cart basket. The support includes a horizontal bar which resides in a horizontal plane coincident with the handle of the shopping cart. An upper bar limits the quantity of 2×4 pieces of lumber which can by accommodated by the support to one. The support of Werner cannot fold into a retracted position when the cart is nested within an adjacent cart. Therefore, in order to nest a cart with the support of Werner, one would have to manually lift the support out of the sockets prior to nesting of the carts. Such a requirement is unnecessary and cumbersome. Moreover, it permits for the misplacement of the support, as it is not attached to the basket.

Thus, there is a need in the art for a conventional type cart that can easily and safely be retrofitted or originally manufactured with a front wall that can be displaced to allow room for heavy items to be placed therein without raising the item over the top of the basket handle, and additionally or alternatively for support structure which can safely support longer items that do not fit well inside the curt without interfering with the cart's ability to be nested within an adjacent cart.

### SUMMARY OF THE INVENTION

The present invention is a shopping cart having a displaceable front wall, with or without a load carrying apparatus associated with the front wall to provide a horizontal support for safely carrying loads that are longer than the length of the cart and must sit on top of the cart basket to be transported.

### DESCRIPTION OF THE DRAWINGS

The invention will be better understood upon reading the following detailed description in conjunction with the drawings, in which;

FIG. 1 is a right rear perspective view of a first embodiment of the shopping cart front wall of this invention incorporating an article support thereon.

FIG. 2 is a right side elevational view thereof.

FIG. 3A is a right side elevational view of a conventional nestling type shopping cart showing the first embodiment of the front wall of this invention hingedly connected thereto and residing in a first retracted (i.e. stored) position under the floor of the cart basket.

FIG. 3B is identical to FIG. 3A, with the exception that the front wall is rotated into the upright, in-use, position.

FIG. 3C is a close up of the area of detail shown in FIG. 3B.

FIG. 3D is identical to FIGS. 3A and 3B, but shows the support in a second retracted (i.e. stored) position above the floor of the cart basket.

FIG. 4 is a right side devotional view of the cart of FIGS. 3A-3D showing the directions of movement of the treat wall.

FIG. 5 is a side elevational view of the front wall in the upright position supporting long articles.

FIG. 6 is a right front perspective view of the basket with the front wall removed.

FIG. 7 is right cross-sectional side elevational view of the preferred embodiment of the shopping cart basket front wall of this invention displaceably connected to the basket.

FIG. 8 is a right front perspective view of the basket of this invention with the the first embodiment of the front wall positioned in the upright, in-use, position.

FIG. 9 is a right front perspective view of the basket of the first embodiment of this invention with the front wall attached and in the first retracted position.

FIG. 10 is a right front perspective view of the basket of the first embodiment of this invention with the front wall attached and in the second retracted position.

FIG. 11 is a right rear perspective view of a second embodiment of the shopping cart front wall of this invention without an article support thereon.

FIG. 12 is aright side devotional view thereof.

FIG. 13 is a right side devotional view of the cart of FIGS. 3A-3D showing the directions of movement of the front wall of FIG. 11.

FIG. 14 is a right front perspective view of the basket of this invention with the second embodiment of the ant wall positioned in the upright, in-use, position.

### DETAILED DESCRIPTION

In this document, relational terms, such as “first” and “second,” “top” and “bottom,” and the like, may be used Solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. A claim element proceeded by the article “a” or “an” does not, without more constraints, preclude the existence of additional identical elements in the process, method, article, or apparatus that includes the element.

The present invention is a conventional shopping cart having nestable or non-nestable baskets, with a front wall that is rotatable arid translatable between a first retracted position in which the front wall is positioned below and substantially parallel to the floor of the basket, an in-use, position in which the front wall is substantially upright, and a second retracted position in which the front wall is positioned substantially on top of the floor of the basket. The front wall may include an article support structure which is utilized together with the push handle to provide a leveling support for safely carrying loads that are longer than the length of the cart and must sit on top of the cart basket to be transported. Shopping carts having front walls which employ such leveling supports are disclosed in my prior pending U.S. patent application Ser. No. 12/231,837, filed Sep. 5, 2008, the disclosure of which is incorporated herein by reference as though fully set forth herein.

The displaceability of the front wall allows the front wall of the basket to be completely removed to allow free access to place articles into or remove articles from the basket with ease.

The novel front wall, whether with or without the article support structure, may be built into the basket of a new cart or it may be retrofitted to an existing cart basket.

A shopping cart typically comprises a frame 2 having four wheels 6 and a push handle 40, and a basket 12 that is attached to frame 2. Basket 12 is comprised of a rear wall 8, front wall 14, bottom wall 16, and opposing sidewalls 15, 17. The cart shown in the FIGS is of the nesting type which allows for compact storage of a number of carts and, accordingly, basket 12 is tapered as is well known with its front wall 14 being smaller (e.g. shorter and narrower) than its rear wall 8. The result is that the uppermost structural member, such as top wire 29 of basket 12, is not level. As nesting carriages are well-known in the art, details of how rear wall 8 swings forward and upward to provide au opening for nesting of carts 12 are not shown or described. In addition, the mesh work of the bottom 16 and four walls 8, 14, 15 and 17 of basket 12 is not shown in full detail as those details are well known. Further, shopping carts in use today sometimes have baskets 12 made of a rigid, metal mesh (as shown in the Figures), and sometimes they are made of a molded, tough plastic mesh (not shown). It is to be understood that the invention described herein may be used with both such carts, as well as any other types of carts.

When the novel front wall is built into a new cart its elements are semi-permanently, hingedly, attached to the cart basket. When the novel front wall is to be retrofitted to an existing cart, the support is attached to the cart basket in substantially the same manner as if it had been installed during the original manufacturing of the cart.

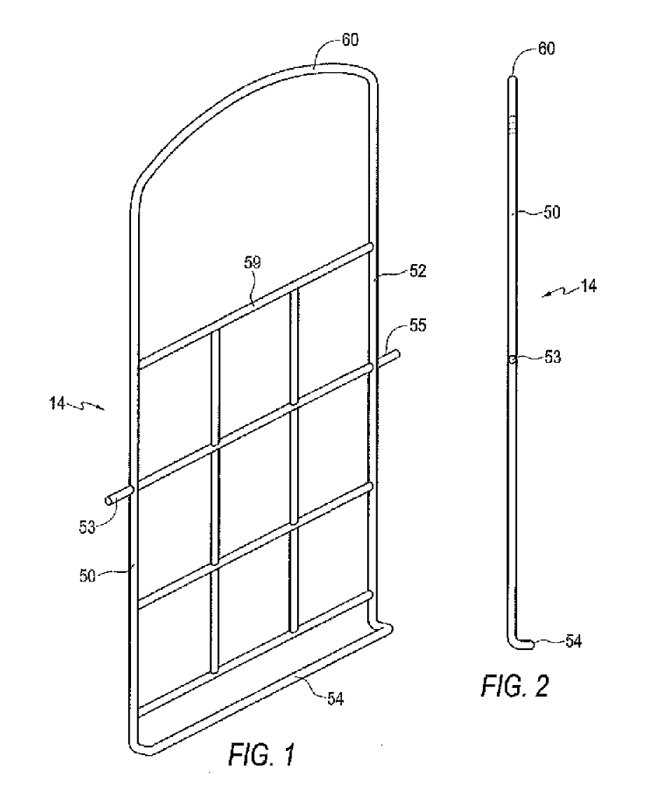

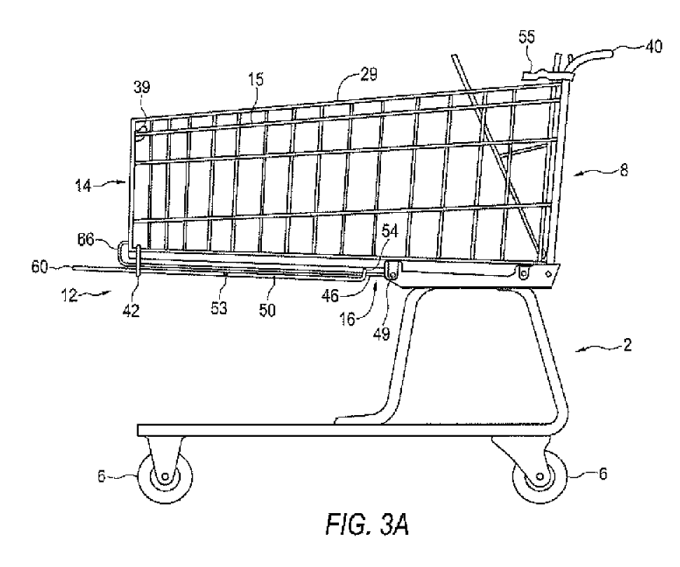

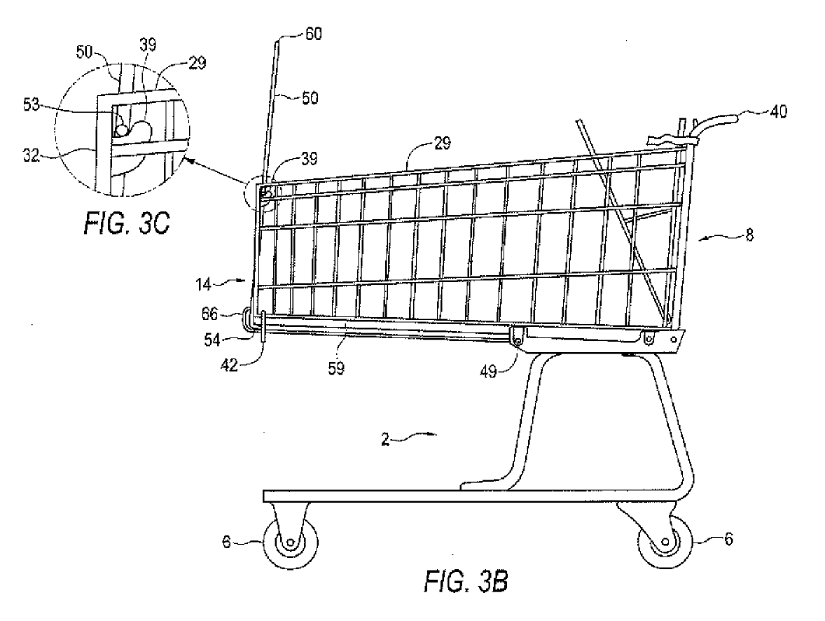

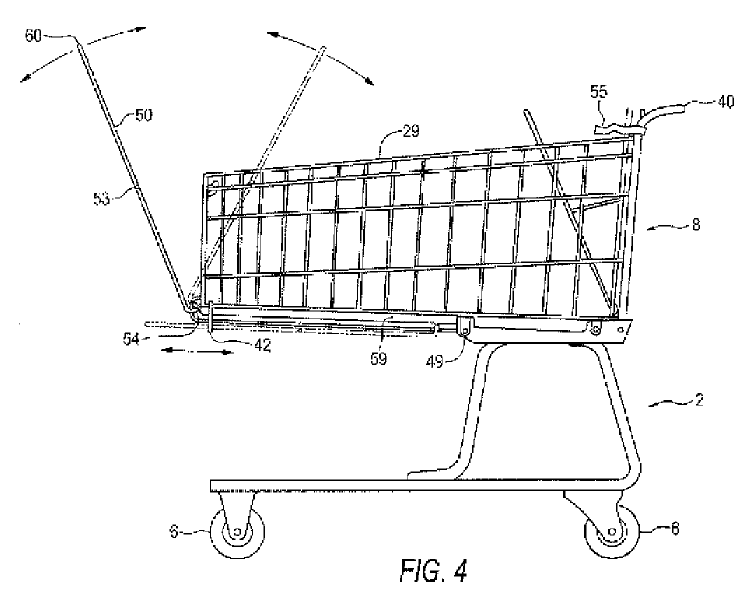

As best seen in FIG. 1, the invention, in the preferred embodiment but not by way of limitation, comprises in part a modified cart basket having a front wall opening defined by opposed substantially vertically oriented wires 30, 32 and lower wire 36 which form an opening through which articles (not shown) can be passed without the necessity of lifting the articles above the top wire 29. As best seen in FIGS. 1-2, the invention also comprises a novel front wall 14 which, in the preferred embodiment but not by way of limitation, includes a pair of substantially vertical legs 50, 52, a lower substantially horizontal cross bar 54, and an upper substantially horizontal cross bar 59. A plurality of intermediate stringers or wires as shown may be employed as will occur to the skilled artisan. Cross bar 59 is positioned between legs 50, 52 at a height which substantially corresponds to the height of the cart handle 40 such that the support bar and the handle lie in substantially the same horizontal plane when the front wall is oriented in the in-use position shown in FIGS. 3B and 5. Thus, when a long load, such as lumber or pipe, sits on top of the handle 40 of the basket and on top of the cross bar 59, the load is oriented substantially horizontally and does not, therefore, easily fall off.

In addition, a pair of retention tabs 53, 55 extend from the sides of legs 50, 53, respectively, which are adapted to be held in releasable engagement by corresponding respective tab sockets 39, 37 associated with basket 12 when front Wail 14 is held in the in-use position shown in FIGS. 3B and 5.

Also, preferably, the legs 50, 52 extend above the height of the cross bar 59 to act as lateral retention members which hold the articles being carried from sliding off of the support member to the side. Still further, a lop bar 60 extending between the uppermost ends of the legs 50, 52 may, preferably, but not by way of limitation, be employed to limit the area through which articles may be placed when being carried by the front wall 14, and the top bar 60 may be arched or sloped to discourage the placement of any articles on top of the top bar 60, since the arched or sloped shape of the top bar will tend to cause any articles resting thereon to slide off.

A lower support wire 42 extends from a lower forward portion of sidewall 15 to a lower forward portion of sidewall 17. Wire 42 may be hingedly connected to lower basket member 61, or may be attached to any other part of the basket in the vicinity of the front of the cart. Wire 42 may be hingedly, as shown, or fixedly attached to the basket 12. Wire 42 and the bottom edge of member 61 from a space through which front wall 14 passes when being moved between the first retracted position shown in FIG. 3A and the in-use position shown in FIG. 3B. One or more guide rods or front wall supporting stringers 44, 46 may be used to support front wall 14 when in the first retracted position. Rods 44, 46 may be supported by apertures 45, 47 in cross rod 49. Cross rod 49, in turn, is supported by lower basket member 61. Guide rods 44, 46 are preferably curved near their forward ends 64, 66, respectively, to cause the lower wire 54 of front wall 14 to be guided over and about forward ends 64, 66 of rods 44, 46 when being moved between the three positions mentioned previously.

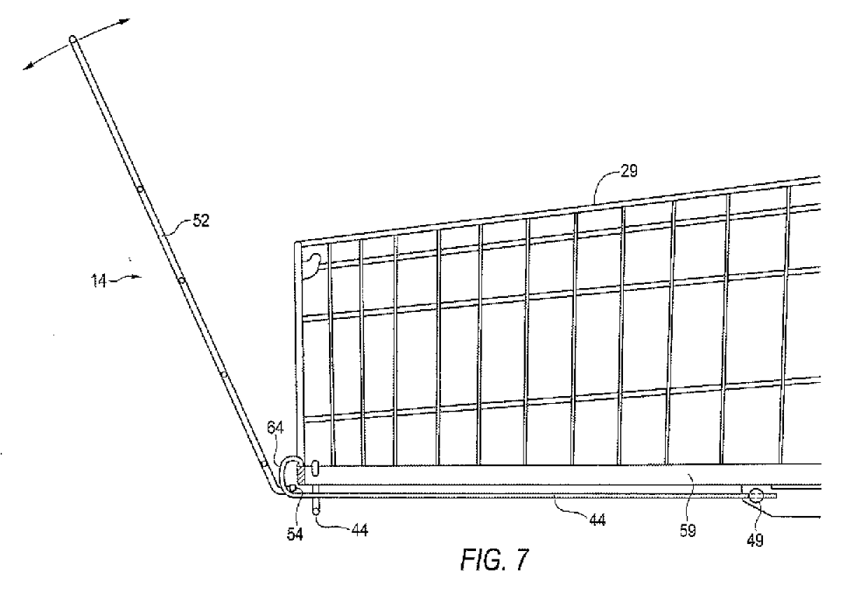

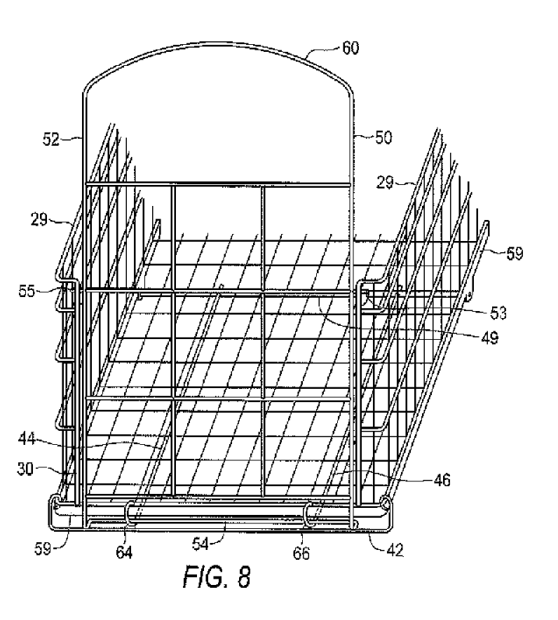

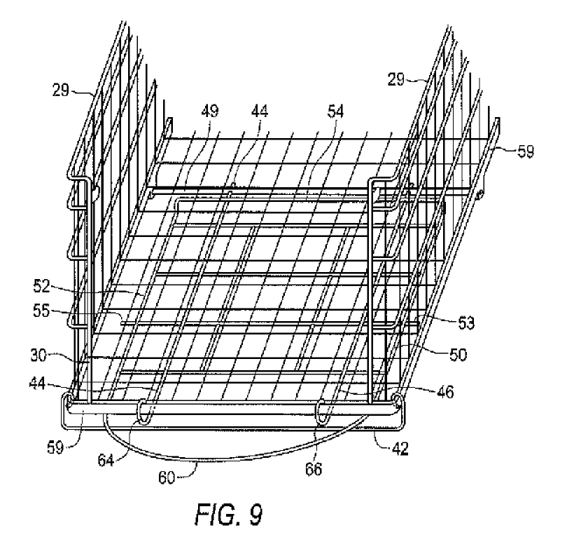

The front wall 14 is movable between a first retracted position in which it lays substantially flat against the bottom wall 16 of the cart basket (shown in FIGS. 3A and 9), allowing the basket 12 to be nested into an adjacent cart, an in-use position in which it is substantially vertical and rests against tabs 37, 39 (shown in FIGS. 3B and 8), and a second retracted position in which the front wall 14 is positioned on top of and substantially within the basket (shown in FIGS. 3D and 10). When a load such as pieces of 2×4 lumber L (shown in FIG. 5) longer than can fit inside the basket 12 are to be transported, the front wall 14 is swung into the in-use position where it is releasably held against tabs 37, 39 of basket 12.

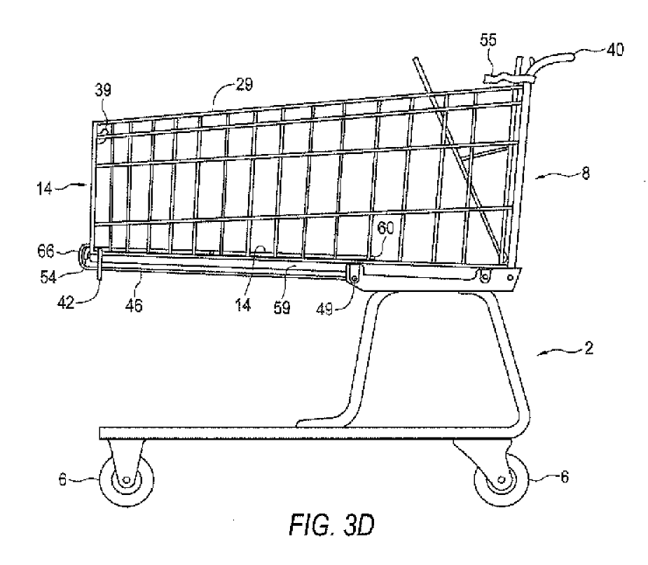

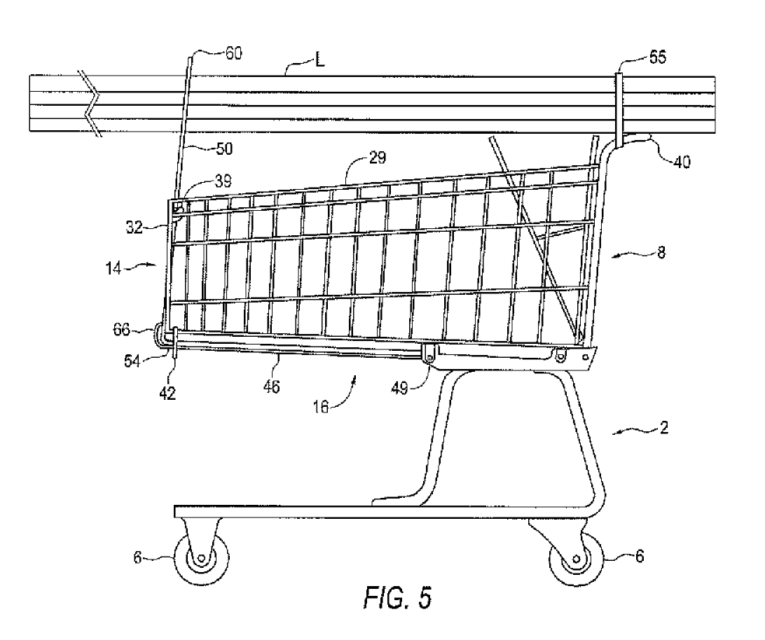

Front wall 14 is rotatably disposed about the interconnection of forward ends 64, 66 of guide rods 44, 46 by virtue of lower wire 54 being looped through forward ends 64, 66. Lower wire 54 of front wall 14 is prevented from being translated in a horizontal direction relative to floor 16 of cart basket 12 when front wall 14 is in the position shown in FIG. 3D because wire 54 cannot proceed past the intersections 65, 67 of forward ends 64, 66 with bottom wire 61 of basket 12. From the second retracted position shown in FIGS. 3D and 10, front wall 14 can be rotated about the juncture of lower front wall wire 54 and forward ends 64, 66 in a counterclockwise direction from the perspective of FIGS. 3A-3D until extension tabs 53, 55 are brought into nesting engagement with sockets 39, 37, respectively, attached to basket wires 32, 30 (shown in FIG. 6). In order to cause extension tabs 53, 55 to nest within tab sockets 39, 37, the user simply lifts front wall 14 upwardly slightly when moving front wall 14 into the position shown in FIGS. 3B, 5 and 8. In order to move front wall from the in-use position to the first retracted position shown in FIGS. 3A and 9 (and in phantom in FIG. 4), the user simply raises front wall 14 enough so that extension tabs 53, 55 move out of engagement with sockets 39, 37, respectively, move over the top of wires 29, 30 and 32 of basket 12, moves front wall in a counterclockwise direction as shown in FIG. 4 such that lower wire 54 of front wall 14 rotates about forward ends 64, 66 of guide rods 44, 46, whereafter lower wire 54 can be slid along the upper surfaces of guide rods 44, 46. As can be seen in FIG. 3A, front wall 14 rests upon cross wire 42 when in the first retracted position shown in FIG. 3A.

For all embodiments, retention tabs 53, 55 may be positioned anywhere on legs 50, 52. All that is necessary is that the one or more retention tabs 53, 55 that are employed line up with a structural member, such as sockets 37, 39 of the cart basket. In other words, tabs 53, 55 may be connected to legs 50, 52 at points which are lower than shown in the drawings so long as tabs 53, 55 line up with socket structure to releasably retain front wall 14 in the in-use position shown in FIGS. 3B and 5. Therefore, tabs 53, 55 may alternatively be positioned on legs 50, 52 such that they extend to the front or rear, not toward the sides, of the basket 12, and releasably engage corresponding wires or other structural members of the sidewalls of basket 12. Also, retention tabs 53, 55 may extend the entire length of legs 50, 52, so that they will essentially form a single retention tab. Alternatively, mention tabs 53, 55 may be positioned anywhere on legs 50, 52, so long as they function to reliably retain front wall 14 in the in-use position and support the weight load imposed by articles L. Further alternatively, retention tabs such as 53, 55 may be attached to the basket and sockets such as 37, 39 may be attached to the basket 12 so as to cooperate with tabs 53, 55 in the manner set forth previously.

Strap 75 may be attached to either side of the handle 40 and may be wrapped around the articles “L” when they are on the cart handle 40. Such a strap is currently used on existing carts as a seal belt for children riding in the child seat on the cart. The strap used on this invention will either he a longer strap than the existing one or will attach to the existing one as an extension,

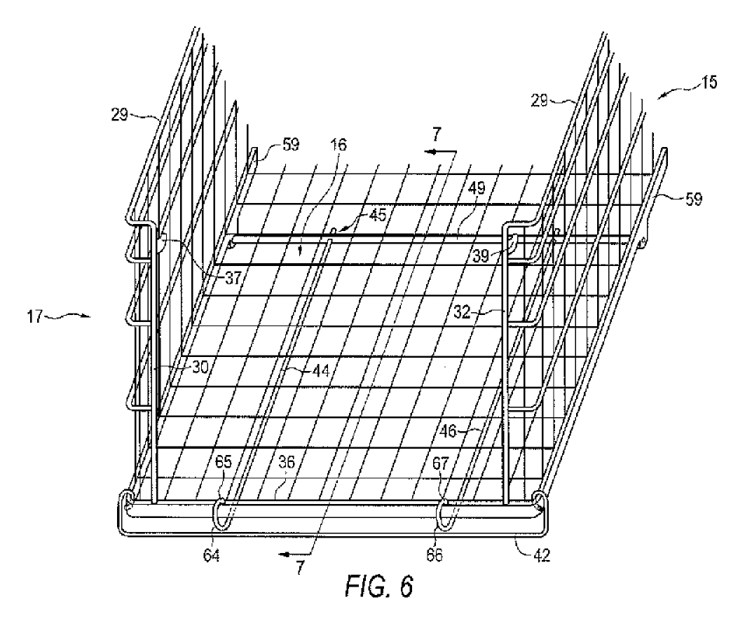

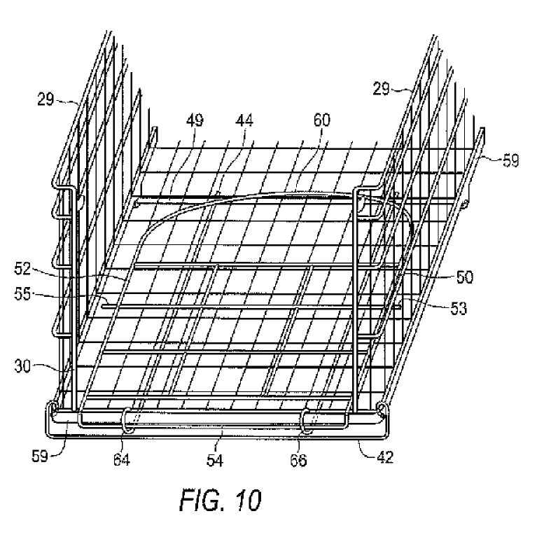

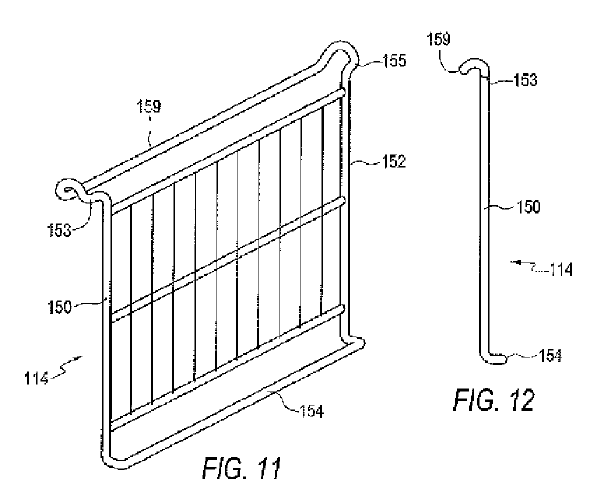

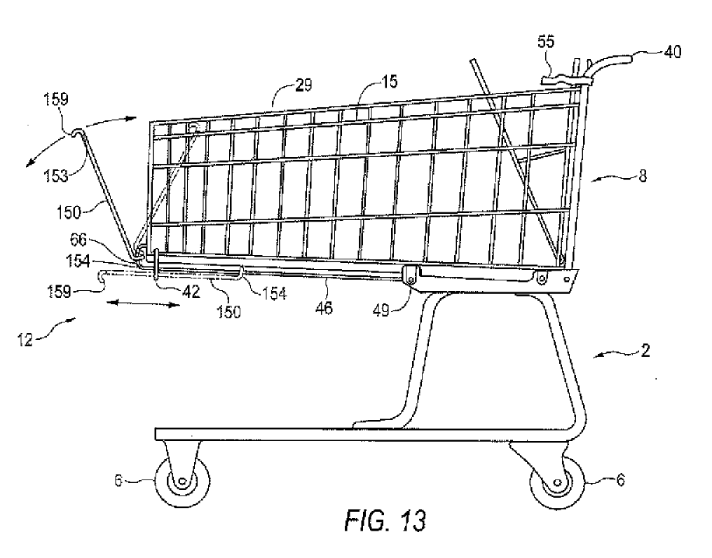

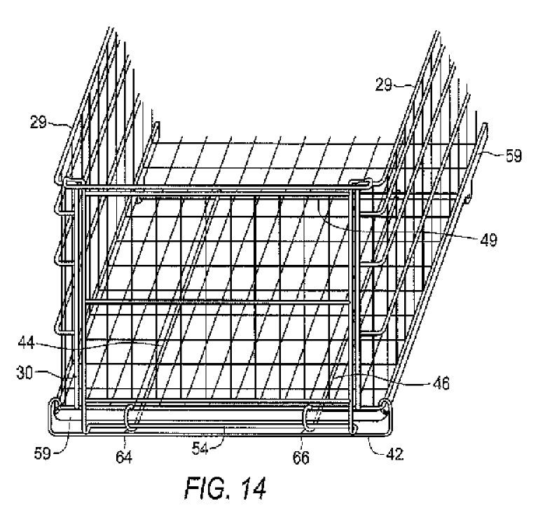

FIGS. 11-14 show a modified loran of the front wall of the shopping cart, in which shortened front wall 114 is hingedly connected to basket 12 in the same manner as front wall 14 in FIGS. 1-10. However, front wall 114 does not extend substantially above the top bar 29 of basket 12. Nevertheless, this shortened front wall 114 can rotate between the first retracted, in-use and second retracted positions relative to basket 12 in the manner described in connection with FIGS. 1-10.

Top bar 159 of shortened front wall 114 may be manufactured with a slight bend 153, 155 to act as a catch, wherein, when front wall 114 is rotated and slid under basket 12, top bar 159 will contact cross wire 42 so as to prevent hunt wall 114 from sliding so far under basket 12 as to make it difficult to retrieve front wall 114 when it is desired to move limit wall 114 from the first retracted position, wherein it is oriented below floor 16 of basket 12, into the in-use position. By “in-use position” is meant a position where bends 153, 155 are in engagement with tab engagement shoulders 137, 139 of basket 12.

For all embodiments of the invention, the area(s) bounded by support legs 50, 52 and 150, 152, and upper and lower cross bars 59, 54 and 159, 154, tray be used to display advertising, safety or warning messages, or other informational matter (not shown).

In the foregoing specification, the present invention has been described with reference to specific embodiments. However, one of ordinary skill in the art appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention.

We claim:

1. A shopping cart, the shopping cart being characterized as having a basket formed of a plurality of wires arranged to define a shopping cart basket, the basket having an upper basket edge defined by an uppermost wire, the basket having a lower basket edge defined by a lowermost wire, and the basket including left and right walls and a floor, the floor defining upper and lower sides thereof, the front wall comprising:
first and second support legs;
a lower crossbar connecting the first and second support legs to each other;
at least one retention structure associated with one or both of the first and second support legs for releasably engaging corresponding structure of the basket to releasably retain the front wall in an in-use position in which the front wall stands substantially upright to act as a front wall of the basket;
at least one front wall guide stringer connected to the basket between the lowermost wire of the basket and a position on the lower side of the floor of the basket;
the lower crossbar adapted to slide on the at least one stringer so as to guide the front wall between a first retracted position where it is laying substantially flat against the floor of the basket and within the basket, an in-use position in which the front wall stands substantially upright to act as a front wall of the basket, and a second retracted position in which it lays substantially flat against the underside of the floor of the basket.

2. The shopping cart of claim 1, wherein the at least one stringer defines at least one curved section thereof.

3. The shopping cart of claim 1, further including a second cross bar connecting the first and second support legs to each other, the second cross bar adapted lo support long articles carried by the shopping cart when the front wall is placed in the in-use position.

4. A shopping cart, the cart being characterized as having a cart basket comprised of:
a floor, left a right side walls, and a front wall, the floor defining a forward edge, each side wall defining a forward edge, the forward edge of the floor and the forward edges of the loft and right side walls defining an open area at the front of the cart basket, the front wall being movably positionable relative to the cart basket between an in-use position in which the front wall is situated substantially within the area at the front of the cart basket and a first retracted position in which the front wall lays substantially in registry with the floor of the basket.

5. The shopping eat of claim 4, wherein the front wall is comprised of:
first and second support legs;
a lower crossbar connecting the first and second support legs to each other.

6. The shopping cart of claim 5, wherein the front wall further comprises:
at least one retention structure associated with one or both of the first and second support legs for releasably engaging corresponding structure of the basket to releasably retain the front wall in the in-use position.

7. The shopping cart of claim 5, further comprising:
at least one front wall guide stringer connected to the basket between the forward edge of the floor and a position on the lower side of the floor of the basket;
the lower crossbar adapted to slide on the at least one stringer so as to guide the front wall between the first retracted position, the it-use position, and a second retracted position in which the front wall lays substantially in registry with the underside of the floor of the basket.

8. The shopping cart of claim 6, further comprising:
at least one front wall guide stringer connected to the basket between the forward edge of the floor and a position on the lower side of the floor of the basket;
the lower crossbar adapted to slide on the at least one stringer so as to guide the front wall between the first retracted position, the in-use position, and a second retracted position in which the front wall lays substantially in registry with the underside of the floor of the basket.

9. The shopping cart of claim 7, further comprising a cross wire connected to the cart basket adapted to support the front wall when the front wall is in the second retracted position.

10. A shopping cart having a displaceable front wall, the cart having a basket comprised of left and right side walls, a floor and a front wall, the front wall being releasably connectable to at least one of the left and right side walls to releasably retain the front wall in an in-use position, the front wall being movable from the in-use position to a first retracted position in which the front wall is placed substantially in registry above the floor of the basket, the front wall also being moveable into a second retracted position in which the front wall is placed substantially in registry below the floor of the basket.

11. The shopping cart of claim 10, wherein the front wall is comprised of:
first and second support legs;
a lower crossbar connecting the first and second support legs to each other.

12. The shopping cart of claim 11, further comprising a cross wire adapted to support the front wall when the front wall is in the second retracted position.

13. The shopping cart of claim 12, further comprising at least one longitudinal guide stringer adapted to guide the lower crossbar while the front wall is being moved between the first retracted, in-use and second retracted positions.
